(19) United States
(12) Patent Application Publication
(10) Pub. No.: US 2022/0028013 A1
(43) Pub. Date: Jan. 27, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Naoki UENOYAMA, Nisshin-shi (JP); Hideo HASEGAWA, Nagoya-shi (JP); Yuya KOKUBUN, Nagoya-shi (JP); Kaede ABE, Nagoya-shi (JP)

(73) Assignee: TOYOTA JIDOSHA KABUSHIKI KAISHA, Toyota-shi (JP)

(21) Appl. No.: 17/381,647

(22) Filed: Jul. 21, 2021

(30) Foreign Application Priority Data
Jul. 22, 2020 (JP) 2020-124931

(51) Int. Cl. G06Q 50/14; G06Q 10/02; G06Q 10/06; G06Q 10/10; G06Q 40/08; G01C 21/34

(52) U.S. Cl. CPC G06Q 50/14; G06Q 10/02; G06Q 10/06313; G06Q 10/109; G06Q 50/26; G06Q 10/063112; G06Q 40/08; G01C 21/3438; G06Q 10/06315

(57) ABSTRACT

The present disclosure provides a technique for improving the convenience of a user using a company car. An information processing apparatus obtains conference information including a venue of a conference, date and time of the conference, and information on at least one attendee user who is a user to attend the conference. In addition, the information processing apparatus books the venue of the conference based on the conference information and sets a schedule of the attendee user based on the conference information. Furthermore, the information processing apparatus books a company car for transporting the attendee user to the venue of the conference.

### CROSS REFERENCE TO THE RELATED APPLICATION

This application claims the benefit of Japanese Patent Application No. 2020-124931, filed on Jul. 22, 2020, which is hereby incorporated by reference herein in its entirety.

### BACKGROUND

### Technical Field

The present disclosure relates to a technique for managing vehicles (company cars) that are lent to employees.

### Description of the Related Art

In a conventionally known technique, a driving schedule table of a company car is created and the created driving schedule table is transmitted to a navigation device of the company car, thereby allowing navigation to be automatically initiated based on the driving schedule table (for example, see Patent Literature 1).

Patent Literature 1: Japanese Patent Laid-Open No. 2012-093132

### SUMMARY

It is an object of the present disclosure to provide a technique for improving the convenience of a user using a company car.

The present disclosure can be considered as an information processing apparatus.

In this case, the information processing apparatus may include, for example, a controller configured to execute:

obtaining conference information including a venue of a conference, date and time of the conference, and information on at least one attendee user, the at least one attendee user being a user to attend the conference;

booking the venue of the conference based on the conference information;

setting a schedule of the attendee user based on the conference information; and

booking a company car for transporting the attendee user to the venue of the conference.

The present disclosure can also be considered as an information processing method.

In this case, the information processing method may cause, for example, a computer to perform:

obtaining conference information including a venue of a conference, date and time of the conference, and information on at least one attendee user, the at least one attendee user being a user to attend the conference;

booking the venue of the conference based on the conference information;

setting a schedule of the attendee user based on the conference information; and

booking a company car for transporting the attendee user to the venue of the conference.

In addition, the present disclosure can also be considered as a program for implementing the above information processing method or a non-transitory storage medium storing the program therein.

According to the present disclosure, a technique that allows an efficient booking management of company cars can be provided.

### BRIEF DESCRIPTION OF THE DRAWINGS

FIG. 1 is a diagram illustrating an overview of a company car management system to which the present disclosure applies;

FIG. 2 is a diagram illustrating an example of conference information;

FIG. 3 is a block diagram schematically illustrating one example of components included in the company car management system;

FIG. 4 is a diagram illustrating a configuration example of a booking information table in an embodiment;

FIG. 5 is a diagram illustrating a configuration example of a user information table in the embodiment;

FIG. 6 is a first diagram illustrating another configuration example of the user information table in the embodiment;

FIG. 7 is a second diagram illustrating another configuration example of the user information table in the embodiment;

FIG. 8 is a diagram illustrating a configuration example of a vehicle information table in the embodiment;

FIG. 9 is a flowchart illustrating a process performed on a server device in the embodiment;

FIG. 10 is a diagram illustrating a configuration example of a booking information table in a first modification; and

FIG. 11 is a flowchart illustrating a process performed on a server device in the first modification.

### DESCRIPTION OF THE EMBODIMENTS

Some company organizations and the like own vehicles (company cars) to be lent out to their employees (users). In such company organizations and the like, a user who attends a conference held outside the office may use a company car. In this case, the user needs not only to book a company car but also to book a venue of the conference, to set schedules of users who attend the conference (attendee users), and the like. If these procedures are separately performed, the work of the user may be complicated.

In an information processing apparatus according to the present disclosure, a controller obtains a venue of a conference, date and time of the conference, and information on at least one attendee user who attends the conference (conference information). The conference information may be provided to the information processing apparatus via a terminal by a user who hosts the conference or a user who is an organizer of the conference (hereinafter, referred to as “host user”).

The controller of the information processing apparatus books the venue of the conference based on the conference information. Such a booking is made based on, for example, information on the venue of the conference and information on the date and time of the conference which are included in the conference information.

The controller of the information processing apparatus sets schedules of the attendee user based on the conference information. Such a setting is made based on, for example, information on the date and time of the conference and information on the attendee users which are included in the conference information. In this case, the controller may transmit information for encouraging attendance at the conference, information on the venue of the conference, and information on the date and time of the conference, to a terminal used by the attendee user. Alternatively, the controller may transmit an instruction to register the date and time of the conference, to an application program for schedule management (hereinafter, may be described as “schedule management application”) which has been installed in the terminal used by the attendee user.

The controller of the information processing apparatus books a company car for transporting the attendee user to the venue of the conference, based on the above conference information. Such a booking is made based on, for example, information on the venue of the conference and information on the date and time of the conference which are included in the conference information. In this case, the controller, for example, extracts a bookable company car based on both the time required for a round trip between a departure place and the venue of the conference and the date and time of the conference, and books the extracted company car.

According to the information processing apparatus configured as described above, a host user does not need to separately perform booking of a conference venue, schedule setting of each attendee user, and booking of a company car. This allows the convenience of a user who uses a company car to be improved.

In addition, in booking of a company car, the controller of the information processing apparatus may book the company car of a model or number of cars according to the number of attendee users. This can save the host user from having to select a model or number of cars of units of a company car, and the like.

When there are a plurality of the attendee users and at least one attendee user out of the attendee users makes a trip to the conference venue from a location (for example, workplace) different from a location of the other attendee users, the controller of the information processing apparatus may book a company car for each location. This can save the host user from having to book a company car for each location. Alternatively, the controller may perform: setting of a travel route of sequentially passing through each location and reaching to the conference venue; and transmission of an instruction to perform route guidance based on the travel route, to a car navigation system mounted on a company car to be booked. This can save the work of having to book a company car for each location and can also save an occupant of the company car from having to set the above travel path in the car navigation system.

When there are a plurality of attendee users, the controller may select a driver candidate that is an attendee user candidate for driving the company car to be booked, from the plurality of attendee users. This can save an attendee user from having to determine a driving user. In addition, the controller may extract an attendee user having the highest safe driving level among the plurality of attendee users based on a driving track record of each of the plurality of attendee users and select the extracted attendee user as the driver candidate. The “driving track record” here may be, for example, information on the number of accidents caused by each of the plurality of attendee users in the past. In this case, the controller may select, as the driver candidate, an attendee user who caused the least number of accidents, among the plurality of attendee users. In addition, the “driving track record” may be information on a driving evaluation of each of the plurality of attendee users. In this case, the controller may select, as the driver candidate, an attendee user having the highest evaluation, among the plurality of attendee users. The evaluation of each attendee user may be, for example, an evaluation that is made by another user who has ridden on a company car driven by the each attendee user in the past. In addition, the “driving track record” may be information on a grade of car insurance of each of the plurality of attendee users. In this case, the controller may select, as the driver candidate, an attendee user having the highest grade of car insurance, among the plurality of attendee users. Since the driver candidate thus selected drives a company car, the safety can be improved.

However, it is also envisaged that there may be no attendee user suitable as the driver candidate among the plurality of attendee users. In this case, the controller may transmit, to a terminal used by a host user, information for encouraging a trip by a public transport service. This can prevent a deterioration of safety in the attendee users making a trip to the conference venue.

Here, the controller of the information processing apparatus may determine a seat position of an attendee user on the company car to be booked. In addition, the controller may cause either a display device mounted on the company car to be booked or a terminal used by the attendee user to display the seat position of the attendee user at a timing when the attendee user gets on the company car to be booked. This can save the attendee user from having to determine its seat position.

In addition, it is also envisaged that an attendee user may not desire to make a trip by a company car. In this case, the controller of the information processing apparatus may transmit, without booking a company car, information on a public transport service available when the attendee user makes a trip to the conference venue, to a terminal which the attendee user uses. This can save the attendee user from having to find, in advance, a public transport service that is available in making a trip to the conference venue.

Furthermore, it is also envisaged that a company car for transporting an attendee user to a venue of a conference may not be able to be booked (that there may be no company car available on the date and time of the conference). In this case, the controller of the information processing apparatus may transmit information on a public transport service that is available when the attendee user makes a trip to the venue of the conference, to a terminal used by the attendee users. This can save, when a company car cannot be booked, the attendee user from having to finding in advance a public transport service that is available in making a trip to the conference venue.

Here, the controller of the information processing apparatus may predict the time required for an attendee user to make a trip to the conference venue by a company car (first required time). In addition, the controller may obtain the time required for the attendee user to make a trip to the conference venue by the public transport service (second required time). Then, if the first required time is equal to or less than the second required time, the controller may book a company car. On the other hand, if the first required time is more than the second required time, the controller may transmit information for encouraging a trip by the public transport service to a terminal of the attendee user. This can minimize the trip time that is taken when the attendee user makes a trip to the conference venue.

When there are a plurality of public transport services available in making a trip to the conference venue, the controller may extract a public transport service that requires the minimum time to make a trip to the conference venue, among the plurality of public transport services. Furthermore, the controller may transmit information for encouraging a trip by the extracted public transport service, to the terminal of the attendee user. This can reliably reduce the trip time that is taken when the attendee user makes a trip to the conference venue.

### EMBODIMENT

Hereinafter, a specific embodiment of the present disclosure will be described with reference to drawings. The dimensions, materials, shapes, relative arrangements and the like of the components described in this embodiment are not intended to limit a technical scope of the present disclosure thereto unless otherwise stated.

This embodiment describes an example in which an information processing apparatus according to the present disclosure is applied to a system that manages company cars (hereinafter, may be described as “company car management system”).

<Overview of Company Car Management System>

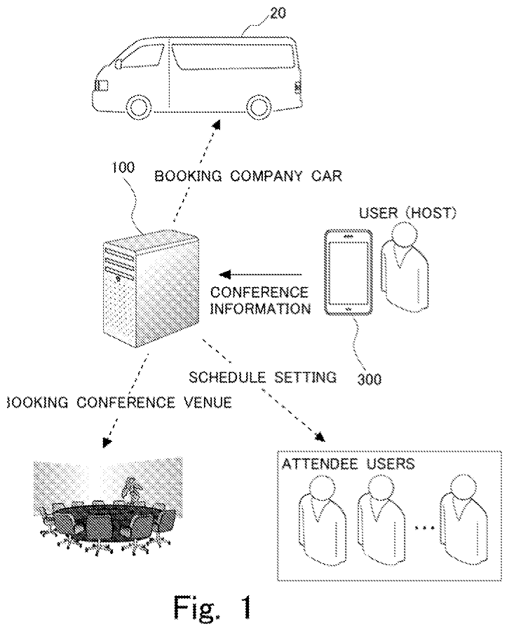

FIG. 1 is a diagram illustrating a schematic configuration of a company car management system according to this embodiment. The company car management system includes, as illustrated in FIG. 1: a vehicle (company car) 20 that is to be lent to a user belonging to a company organization (for example, employee); and a server device 100 that manages lending of the company car 20; and a user terminal 300 used by the user.

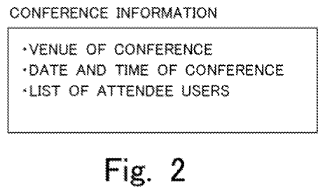

In the company car management system, a user who hosts a conference or a user who is an organizer of the conference (host user) transmits conference information to the server device 100 through the user terminal 300. The “conference information” in this example includes, as illustrated in FIG. 2, information on the venue of a conference, information on the date and time of the conference, and information on users (attendee users) who are to attend the conference (e.g., a list of attendee users). The server device 100 having received the conference information books a company car 20, sets schedules of the attendee users, and the like, in conjunction with the booking of the venue of the conference. The company car 20 to be booked has a later-described on-vehicle device 200 mounted thereon; and the on-vehicle device 200 authenticates user terminals 300 of the attendee users, thereby allowing the attendee users to use the company car 20.

<System Configuration>

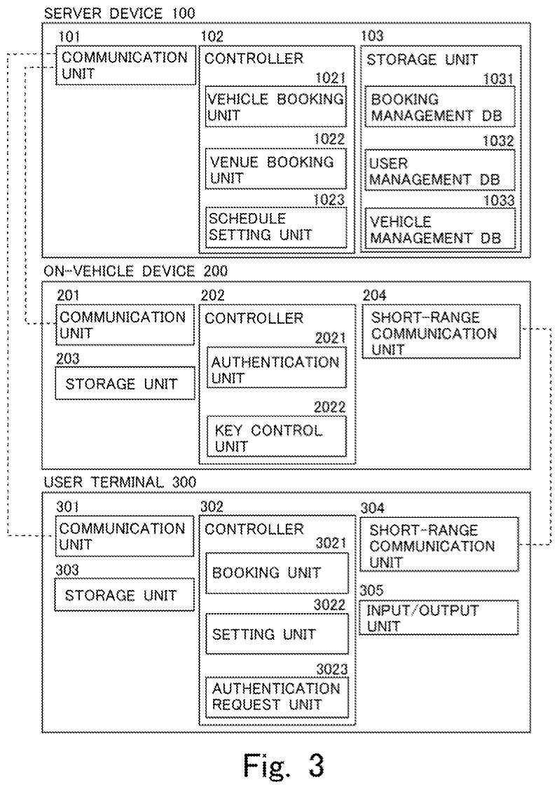

Here, a configuration of the company car management system is described with reference to FIG. 3. FIG. 3 is a block diagram schematically illustrating one example of the configurations of the server device 100, the on-vehicle device 200, and the user terminal 300 which are illustrated in FIG. 1.

(Server Device 100)

The server device 100 is an information processing apparatus that manages company cars 20. The server device 100 books a company car 20, books a conference venue, and sets schedules of attendee users, based on the conference information from the user terminal 300. In addition, it transmits, to the on-vehicle device 200 of the company car 20 to be booked, information related to authentication of the attendee users.

The server device 100 can be configured by a general-purpose computer. For example, the server device 100 includes a processor (CPU, GPU, or the like), a main memory (RAM, ROM, or the like), and an auxiliary memory (EPROM, hard disk drive, removable media, or the like). Examples of the removable media may include a recording medium such as a USB flash drive, CD, or DVD. The auxiliary memory stores an operating system (OS), various programs, various kinds of tables, and the like. The processor executes a program stored in the auxiliary memory and thereby, implements each function corresponding to a predetermined purpose, as described later. Some or all of functions of the server device 100 may be implemented by a hardware circuit such as an ASIC or FPGA.

The server device 100 in this example includes, as illustrated in FIG. 3, a communication unit 101, a controller 102, and a storage unit 103.

The communication unit 101 connects the server device 100 to a network. For example, the communication unit 101 connects with the network by using a mobile communication service such as 5G or LTE. Then, the communication unit 101 communicates with the on-vehicle device 200 or the user terminal 300 via the network.

The controller 102 controls the server device 100. The controller 102 is configured by, for example, a CPU. The controller 102 has function modules such as a vehicle booking unit 1021, a venue booking unit 1022, and a schedule setting unit 1023. These function modules are implemented by the CPU executing a program stored in the storage unit 103.

The vehicle booking unit 1021 manages booking of the company cars 20 managed by the company car management system. More specifically, the vehicle booking unit 1021 first determines a scheduled lending period of a company car 20 based on the venue, and date and time of the conference which are included in the conference information. The scheduled lending period is determined so as to include trip time before and after the date and time of the conference (including the start date and time and end date and time of the conference). The trip time includes: the time required for making a trip from a place where the company car 20 is lent out (for example, a workplace of the attendee users) to the conference venue (outward trip time); and the time required for making a trip from the conference venue to a place where the company car 20 is returned (for example, the same place as where it is rent out) (return trip time). Therefore, the start date and time of the scheduled lending period is a date and time obtained by subtracting the above outward trip time from the conference start date and time. The end date and time of the scheduled lending period is a date and time obtained by adding the above return trip time to the conference end date and time. When the time that is obtained by subtracting the above outward trip time from the conference start date and time is in early morning, a business end time of the previous day may be set as the start date and time of the scheduled lending time. In addition, when the time that is obtained by adding the return trip time to the conference end date and time is in midnight, a business start time of the next day may be set as the end date and time of the scheduled lending time.

When the scheduled lending period is determined by the above procedure, the vehicle booking unit 1021 extracts company cars 20 that can be booked in the scheduled lending period from among company cars 20 managed by the company car management system. The vehicle booking unit 1021 specifies a company car 20 that has a seating capacity that accommodates the number of attendee users or more from among the extracted company cars 20. The vehicle booking unit 1021 books the specified company car 20 for the above scheduled lending period. If there is not a company car 20 that has a seating capacity accommodating the number of attendee users or more among the above extracted company cars 20, the vehicle booking unit 1021 books a plurality of company cars 20 for the above scheduled lending period.

In addition, the vehicle booking unit 1021 has a function of selecting an attendee user (driver candidate) suitable for driving a company car 20 to be booked, from among the attendee users. In this example, the vehicle booking unit 1021 extracts an attendee user having the highest safe driving level from among the attendee users based on driving track records of the attendee users; and selects the extracted attendee user as the driver candidate. For example, the vehicle booking unit 1021 may select, as the driver candidate, an attendee user who caused the least number of accidents in the past, among the attendee users. Alternatively, the vehicle booking unit 1021 may select, as the driver candidate, an attendee user who has the highest evaluation from another user (employee), among the attendee users. In addition, the vehicle booking unit 1021 may select, as the driver candidate, an attendee user who has the highest grade of car insurance, from among the attendee users each of which has the car insurance. Note that the driver candidate does not necessarily need to be determined on a company car management system side but may be determined by consultation among the attendee users.

The venue booking unit 1022 books a conference venue based on the above conference information. Booking of a conference venue can be made by using an existing method. For example, the venue booking unit 1022 books a facility that can be booked on the date and time of the conference and that accommodates more participants than the number of attendee users, from among conference facilities which are provided at the conference venue. If the conference venue is not under management of the company organization, for example, if the conference venue is under management of an external organization or the like, the venue booking unit 1022 may request the organization or the like that manages the conference venue to book the conference venue. In short, the venue booking unit 1022 may transmit a booking request including information on the date and time of the conference and information on the number of attendee users, to the organization or the like that manages the conference venue.

The schedule setting unit 1023 sets schedules of the attendee users based on the conference information. In this example, the schedule is set on which the start date and time of the above scheduled lending period is set as a business trip start date and time and the end date and time of the above scheduled lending period is set as a business trip end date and time. The schedule setting may be performed by the schedule setting unit 1023 through a schedule management application of the user terminal 300. For example, the schedule setting unit 1023 may transmit an instruction to set a conference schedule (hereinafter, may be referred to as “schedule setting instruction”) to the user terminal 300 of each of the attendee users through the communication unit 201. The schedule setting instruction in this case includes information on the business trip start date and time and the business trip end date and time. In the user terminal 300 having received the schedule setting instruction, the schedule management application automatically registers a schedule for attending the conference during a period from the business trip start date and time to the business trip end date and time. Note that schedule setting processing may be manually performed by each attendee user. More specifically, on the user terminal 300, processing of notifying a user of information indicating the business trip start date and time and the business trip end date and time and processing of encouraging an attendee user to register the conference schedule may be performed.

When there are a plurality of attendee users, not all the attendee users make a trip from the same location (for example, the same workplace) to the conference venue. More specifically, it is also envisaged that at least one attendee user out of the attendee users may make a trip to the conference venue from a location different from the one of the other attendee users. In this case, processing of booking a company car 20 by the vehicle booking unit 1021 and processing of schedule setting by the schedule setting unit 1023 may be performed for each location. More specifically, since the outward trip time and return trip time are different for each location, determination of a scheduled lending period and setting of the business trip start date and time and the business trip end date and time may be performed for each location.

The storage unit 103 stores various kinds of information. The storage unit 103 is configured by, for example, a storage medium such as a RAM, a magnetic disk, or a flash memory. In the storage unit 103, various kinds of programs executed by the controller 102, various kinds of data, and the like are stored. In this example, a booking management DB 1031, a user management DB 1032, and a vehicle management DB 1033 are constructed in the storage unit 103. The booking management DB 1031, the user management DB 1032, and the vehicle management DB 1033 are constructed by allowing a database management system (DBMS) program executed by the processor to manage data stored in an auxiliary memory. The booking management DB 1031, the user management DB 1032, and the vehicle management DB 1033 above are, for example, relational databases.

The booking management DB 1031 stores information in which a company car 20, a conference venue, and an attendee user are associated with one another. Here, a configuration example of information stored in the booking management DB 1031 is described with reference to FIG. 4. FIG. 4 is a diagram illustrating a table configuration of information stored in the booking management DB 1031. A table stored in the booking management DB 1031 (hereinafter, may be described as “booking information table”) includes, as illustrated in FIG. 4, fields for a vehicle ID, a lending period, a user ID, a venue, a date and time, and a driver ID. In the vehicle ID field, information for identifying a company car 20 to be booked (vehicle ID) is registered. In this example, a vehicle ID of a company car 20 booked by the vehicle booking unit 1021 is registered in the vehicle ID field. In the lending period field, information on a lending period of a company car 20 is registered. In this example, a scheduled lending period determined by the vehicle booking unit 1021 is registered in the lending period field. In the user ID field, information for identifying a user who rides on the company car 20 to be booked, in other words, an attendee user of a conference (user ID) is registered. The user ID is information that is provided when each user starts working as a new employee; for example, an employee ID for identifying individual users. When there are a plurality of attendee users, user IDs for the plurality of persons are registered in the user ID field. In the venue field, information on a conference venue is registered. In this example, information on a venue booked by the venue booking unit 1022 is registered in the venue field. In the date and time field, information on the date and time of a conference is registered. More specifically, information on the start date and time and end date and time of the conference is registered in the date and time field. In the driver ID field, the user ID of an attendee user who drives the company car 20 to be booked (driver candidate) is registered. In this example, the user ID of the driver candidate selected by the vehicle booking unit 1021 is registered in the driver ID field.

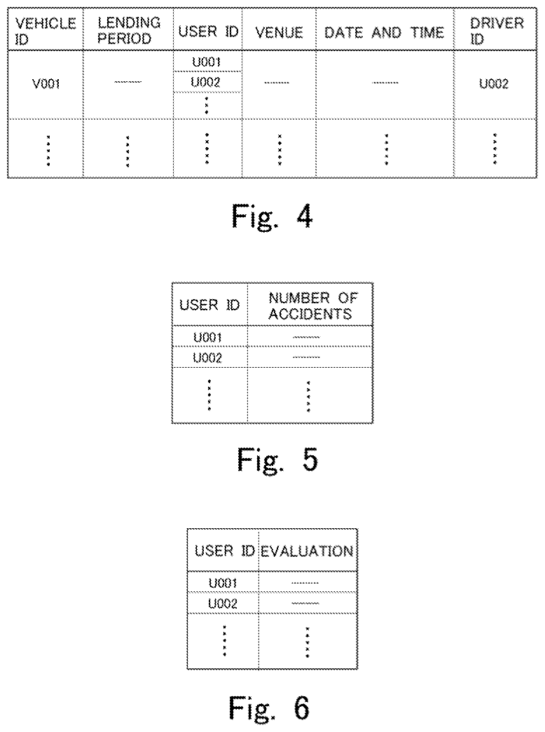

The user management DB 1032 stores information on the driving track records of users who belong to the company organization. Here, a configuration example of information stored in the user management DB 1032 is described with reference to FIG. 5. FIG. 5 is a diagram illustrating a table configuration of information stored in the user management DB 1032. A table stored in the user management DB 1032 (hereinafter, may be described as “user information table”) includes, as illustrated in FIG. 5, fields for a user ID and the number of accidents. In the user ID field, a user ID of each of a plurality of users who belong to the company organization is registered. In the number of accidents field, information on the number of automobile accidents caused by each user in the past is registered. Note that the configuration of the user information table is not limited to the example illustrated in FIG. 5 and is only required to be such that a driving track record correlated with a safe driving level of each user can be grasped. For example, as illustrated in FIG. 6, the user information table may include fields for a user ID and evaluation. In this case, in the evaluation field, information on a driving evaluation of each user by another user is registered. For example, information indicating any one of three grades of “good,” “fair,” and “bad” into which the evaluation is classified may be registered. For a user who has been evaluated by a plurality of other users, the most common evaluation among the evaluations is registered. In addition, the user information table may include fields of a user ID and an insurance grade, as illustrated in FIG. 7. In this case, in the insurance grade field, information indicating a grade of automobile insurance of each user is registered.

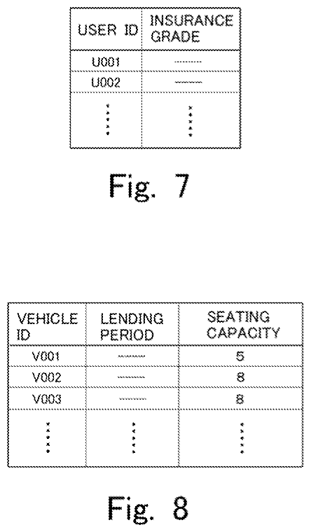

The vehicle management DB 1033 stores information on company cars 20 managed by the company car management system. Here, a configuration example of information stored in the vehicle management DB 1033 is described with reference to FIG. 8. FIG. 8 is a diagram illustrating a table configuration of information stored in the vehicle management DB 1033. A table stored in the vehicle management DB 1033 (hereinafter, may be described as “vehicle information table”) includes, as illustrated in FIG. 8, fields for a vehicle ID, a lending period, and a seating capacity. In the vehicle ID field, a vehicle ID of each of company cars 20 managed by the company car management system is registered. In the lending period field, information on a lending period of each of the company cars 20 is registered. For a company car 20 for which a plurality of bookings have been made, information on a plurality of lending periods are registered in the lending period field. In addition, for a company car 20 not for booking, the lending period field is blank. In the seating capacity field, information on a seating capacity of each of the company cars 20 is registered. For example, for a company car 20 that has a seating capacity of five people, “5” is registered in the vehicle seating capacity field. In addition, for a company car 20 that has a seating capacity of eight people, “8” is registered in the vehicle seating capacity field.

(On-Vehicle Device 200)

Next, the on-vehicle device 200 will be described. The on-vehicle device 200 of this example includes: a function of performing short-range wireless communication with a user terminal 300 and authenticating the user terminal 300; and a function of performing processing such as locking/unlocking of an electronic lock based on a result of authenticating the user terminal 300. The on-vehicle device 200 includes, as illustrated in FIG. 3, the communication unit 201, the controller 202, the storage unit 203, and a short-range communication unit 204.

The communication unit 201 communicates with the server device 100 in accordance with the same communication standard as the communication unit 101 of the server device 100.

The controller 202 communicates with the user terminal 300 through the short-range communication unit 204, thereby authenticating the user terminal 300. In addition, the controller 202 performs processing such as locking/unlocking of the electronic lock, based on a result of the above authentication. The controller 202 is configured by, for example, a microcomputer.

The controller 202 in this example has function modules of an authentication unit 2021, a key control unit 2022, and the like. These function modules are implemented, for example, by a CPU or the like executing a program stored in the storage unit 203.

The authentication unit 2021 performs user authentication based on information obtained from the server device 100 and information obtained from the user terminal 300. For example, the authentication unit 2021 obtains data (authentication data) for authenticating an attendee user (driver candidate) who has booked a company car 20, from the server device 100 in advance. In addition, the authentication unit 2021 communicates with the user terminal 300 through the short-range communication unit 204, to obtain user information of the driver candidate. Then, the authentication unit 2021 compares the authentication data and the user information and if they match with each other, determines that the authentication is successful. If they do not match with each other, the authentication unit 2021 determines that the authentication fails. When the driver candidate is successfully authenticated, the authentication unit 2021 transmits an instruction to unlock the electronic lock of the company car 20, to the key control unit 2022 described later. In this case, the key control unit 2022 unlocks the electronic lock of the company car 20.

The storage unit 203 stores various kinds of information. The storage unit 203 is configured by, for example, a storage medium such as a RAM, a magnetic disk, or a flash memory. In the storage unit 203, authentication data obtained from the server device 100, user information obtained from the user terminal 300, various programs executed by the controller 202, and the like are stored.

The short-range communication unit 204 is an interface for performing short-range wireless communication with the user terminal 300. The short-range communication unit 204 performs short-range communication by using a predetermined wireless communication standard. In this example, the short-range communication unit 204 performs data communication in accordance with the near field communication (NFC) standard. The short-range communication unit 204 may use a wireless communication standard such as Bluetooth (registered trademark), Ultra Wideband (UWB), Wi-Fi (registered trademark), or the like.

The on-vehicle device 200 may include functions other than described above. For example, the on-vehicle device 200 may include a car navigation system function. In addition, the on-vehicle device 200 may be configured so as to be able to execute a function associated with booking of a company car 20 (for example, a function of notifying a return deadline or performing a procedure for extending the return deadline). The functions of the on-vehicle device 200 may be incorporated in a car navigation system mounted on the company car 20.

(User Terminal 300)

Next, the user terminal 300 will be described. The user terminal 300 is a small computer carried by a user. The user terminal 300 is configured by, for example, a smart phone, a mobile phone, a tablet terminal, a personal information terminal, or a wearable computer (such as smart watch). The user terminal 300 includes, as illustrated in FIG. 3, a communication unit 301, a controller 302, a storage unit 303, and a short-range communication unit 304, and an input/output unit 305.

The communication unit 301 is a communication interface for communicating with the server device 100 via a network, as with the communication unit 201 of the on-vehicle device 200.

The controller 302 controls the user terminal 300. The controller 302 is configured by, for example, a microcomputer. The controller 302 has function modules of a booking unit 3021, a setting unit 3022, an authentication request unit 3023, and the like. These function modules are implemented by a CPU executing a program stored in the storage unit 303.

The booking unit 3021 accesses the server device 100 based on information which is input by a user through the input/output unit 305, to request the booking of a conference venue and the booking of a company car 20. More specifically, the user first inputs a conference venue, a conference date and time, attendee users, and the like through the input/output unit 305. Subsequently, the booking unit 3021 generates conference information including the conference venue, the conference date and time, and information on the attendee users. After that, the booking unit 3021 transmits the generated conference information to the server device 100 through the communication unit 301. Note that in this example, the above processing by the booking unit 3021 is executed when the user of the user terminal 300 is a host user.

The setting unit 3022 sets a schedule of a user in accordance with an instruction from the server device 100. More specifically, the setting unit 3022 first obtains a schedule setting instruction from the server device 100 through the communication unit 301. Subsequently, the setting unit 3022 starts the schedule management application to register a schedule for attending a conference for a period between a business trip start date and time and a business trip end date and time. Note that in this example, the above processing by the setting unit 3022 is executed when the user of the user terminal 300 is an attendee user.

The authentication request unit 3023 generates a request for unlocking/locking a company car 20 based on an operation performed by a user; and transmits the generated request to the on-vehicle device 200 through the short-range communication unit 304. For example, the authentication request unit 3023 first outputs an interface screen for unlocking/locking (for example, a screen for displaying an unlock button and a lock button) to the input/output unit 305 (such as a touch panel display). Subsequently, the authentication request unit 3023 generates data for requesting to unlock/lock the electronic lock of the company car 20 (lock/unlock request), based on an operation performed by the user (unlock operation/lock operation) on the above interface screen. After that, the authentication request unit 3023 transmits the generated lock/unlock request to the on-vehicle device 200 through the short-range communication unit 304. The lock/unlock request in this case includes the user information described earlier.

The storage unit 303 stores various kinds of information. The storage unit 303 is configured by, for example, a storage medium such as a RAM, a magnetic disk, or a flash memory. In the storage unit 303, various kinds of programs executed by the controller 302, various kinds of data, and the like are stored. In this example, the user information described earlier is also stored in the storage unit 303, in addition to the above information.

The short-range communication unit 304 performs communication between the on-vehicle device 200 and the user terminal 300 in accordance with the same communication standard as the short-range communication unit 204 of the on-vehicle device 200. In this example, the short-range communication unit 304 transmits the lock/unlock request generated by the authentication request unit 3023, to the short-range communication unit 204 of the on-vehicle device 200.

The input/output unit 305 receives an input operation performed by a user and then, presents information to the user. The input/output unit 305 is composed of, for example: a touch panel and its control circuit; a liquid crystal display and its circuit; and the like. The touch panel and the liquid crystal display may be configured by one touch panel display. In this example, the input/output unit 305 receives an input of information on a conference venue, conference date and time, and attendee users. In addition, the input/output unit 305 outputs an interface screen for unlocking/locking as described earlier.

<Procedure>

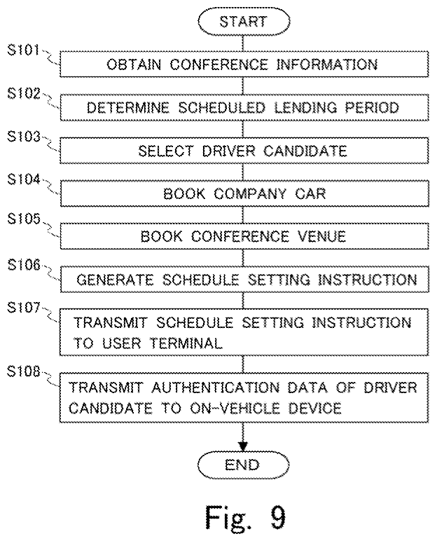

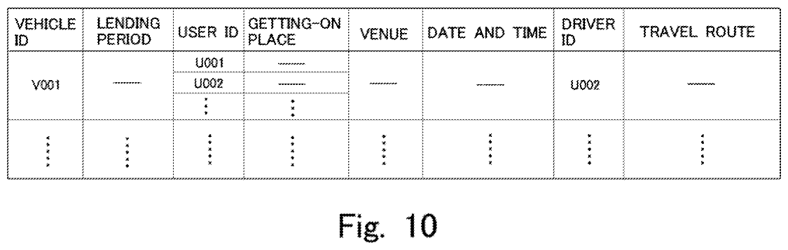

Next, a process performed in the server device 100 in this example will be described with reference to FIG. 9. FIG. 9 is a flowchart illustrating a process performed in the server device 100 when conference information transmitted from the user terminal 300 of a host user is received.

When the host user inputs information on a conference venue, a conference date and time, and attendee users into the user terminal 300 through the input/output unit 305, the booking unit 3021 of the controller 302 generates conference information. The conference information generated by the booking unit 3021 is transmitted to the server device 100 via the communication unit 301. When the conference information is received by the communication unit 101 of the server device 100, the conference information is passed from the communication unit 101 to the controller 102 and thus the controller 102 obtains the conference information (step S101).

In the controller 102, the vehicle booking unit 1021 determines the scheduled lending period described earlier, based on the conference venue, and conference date and time which are included in the conference information (step S102). More specifically, the vehicle booking unit 1021 computes an outward trip time and a return trip time based on a distance between the conference venue and an attendee user's office. Subsequently, the vehicle booking unit 1021 determines a start date and time of the scheduled lending period by subtracting the onward trip time from a conference start date and time. In addition, the vehicle booking unit 1021 determines an end date and time of the scheduled lending period by adding the return trip time to the conference end date and time.

In addition, the vehicle booking unit 1021 selects a driver candidate from among the attendee users (step S103). More specifically, the vehicle booking unit 1021 accesses the user management DB 1032 based on the user IDs of the attendee users which are included in the conference information, to specify user information table associated with each of the attendee users. Subsequently, the vehicle booking unit 1021 extracts information correlated with the safe driving level of each of the attendee users (the number of accidents, evaluation, or a grade of car insurance) from the specified user information table. Then, the vehicle booking unit 1021 selects, as the driver candidate, an attendee user having the highest safe driving level (an attendee user having the least number of accidents, an attendee user having the highest evaluation, or an attendee user having the highest grade of car insurance).

The vehicle booking unit 1021 books a company car 20 based on the number of attendee users and the scheduled lending period (step S104). More specifically, the vehicle booking unit 1021 accesses the vehicle management DB 1033 and extracts company cars 20 that can be booked for the scheduled lending period. In other words, it extracts company cars 20 whose lending period registered in the lending period field does not overlap the above scheduled lending period; and company cars 20 whose lending period field is blank, from among company cars 20 which are managed by the company car management system. Subsequently, the vehicle booking unit 1021 specifies a company car 20 whose seating capacity registered in the seating capacity field is the number of attendee users or more, from among the extracted company cars 20. Then, the vehicle booking unit 1021 books the specified company car 20. In this case, the vehicle booking unit 1021 generates a booking information table, based on a vehicle ID of the company car 20 to be booked, the lending period (scheduled lending period), user IDs of the attendee users, the conference venue, the conference date and time, and a user ID of the driver candidate. After that, the vehicle booking unit 1021 registers the generated booking information table in the booking management DB 1031.

The venue booking unit 1022 of the controller 102 books the conference venue, based on the conference venue, and conference date and time which are included in the conference information (step S105). More specifically, the venue booking unit 1022 extracts a facility that can be booked on the conference date and time and that accommodates more participants than the number of attendee users, from among conference facilities which are provided in the conference venue; and books the extracted facility.

The schedule setting unit 1023 of the controller 102 generates a schedule setting instruction (step S106). The schedule setting instruction causes the user terminal 300 to register a schedule for attending a conference and includes information on a business trip start date and time and a business trip end date and time, as described earlier. The business trip start date and time correspond to the start date and time of the above scheduled lending period. The business trip end date and time correspond to the end date and time of the above scheduled lending period.

The schedule setting unit 1023 transmits the schedule setting instruction generated at step S106, to the user terminal 300 of each attendee user (step S107). On the user terminal 300 having received the schedule setting instruction, the setting unit 3022 starts the schedule management application to register a schedule for attending the conference during a period from the business trip start date and time to the business trip end date and time. At this time, on the user terminal 300, processing for notifying the attendee user that the schedule for the conference has been registered may be performed.

After that, when the start date and time of the scheduled lending period comes, the controller 102 transmits authentication data for authenticating the driver candidate to the on-vehicle device 200 of the company car 20 to be booked (step S108). This allows, when a lock/unlock request is transmitted from the user terminal 300 of the driver candidate to the on-vehicle device 200, the authentication unit 2021 of the on-vehicle device 200 to compare the above authentication data and user information included in the lock/unlock request, thereby authenticating the driver candidate. When the authentication is successful, the electronic lock of the company car 20 is unlocked/locked. Thus, the driver candidate is allowed to use the company car 20. More specifically, the driver candidate is allowed to make a trip to the conference venue with other attendee users on the company car 20.

According to the process in FIG. 9, when a host user of a conference performs an operation for transmitting conference information from the user terminal 300 to the server device 100, not only booking of a conference venue but also booking of a company car 20 and schedule setting of attendee users are automatically performed. This eliminates the necessity of the host user separately performing booking of the company car 20, booking of the conference venue, and schedule setting of the attendee users. Consequently, the convenience of the user who uses the company car 20 to attend the conference can be improved.

<First Modification>

When there are a plurality of attendee users and at least one attendee user out of the attendee users participates from a location different from the one of the other attendee users, a company car 20 may be booked for each of the locations as described above. However, one company car 20 may pass through each of the locations to carry the attendee users participating from the locations, to the conference venue.

Here, a configuration example of a booking information table in this modification is described with reference to FIG. 10. A booking information table illustrated in FIG. 10 includes a getting-on place field and a travel route field in addition to the fields for a vehicle ID, a lending period, a user ID, a venue, a date and time, and a driver ID. In the getting-on place field, information on a place where each of the attendee users gets on the company car 20 (for example, a workplace of each attendee user) is registered. In the travel route field, information on a route from a place where the company car 20 is lent out (starting place) to the conference venue through each getting-on place of each of the attendee users is registered. In this case, the place where the company car 20 is lent out and the travel route may be determined so as to minimize the time that is required to reach the conference venue through each getting-on place from the place where it is lent out. In addition, an attendee user who has the highest safe driving level may be selected as the driver candidate, from among attendee users who depart from the place where the company car 20 is lent out. Alternatively, an attendee user who has the highest safe driving level among the attendee users may be selected as the driver candidate, and a departure place of the driver candidate may be set as a place where the company car 20 is lent out. In addition, a route from the place where the company car 20 is lent out to the conference venue through each getting-on place of each of other attendee users may be set as the travel route.

When a travel route is set in a manner described above, the controller 102 transmits an instruction to perform route guidance based on the travel route (hereinafter, may be described as “guidance instruction”) to an on-vehicle device 200 of the company car 20 to be booked. A timing for transmitting the guidance instruction from the server device 100 to the on-vehicle device 200 is set to a start date and time of the scheduled lending period or to a timing immediately therebefore. In the on-vehicle device 200 having received the guidance instruction, the controller 202 performs route guidance for the driver candidate based on the travel route.

<Procedure>

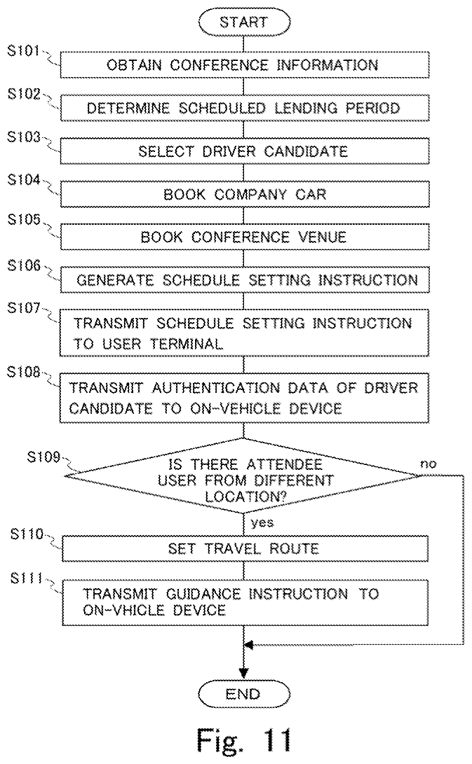

Here, a process performed in the server device 100 in this modification is described with reference to FIG. 11. FIG. 11 is a flowchart illustrating a process performed on the server device 100 when the conference information transmitted from the user terminal 300 of the host user is received. Note that processing similar to that in the process in FIG. 9 described earlier is denoted by the same reference sign.

In the process in FIG. 11, processing at steps S109 to S111 is executed in addition to processing at steps S101 to S108. At step S109, the vehicle booking unit 1021 of the controller 102 determines whether there is an attendee user who participates from a location different from the one of the other attendee users among the conference attendee users. This determination processing is performed based on information registered in the getting-on place field of the booking information table. If there is no attendee user who participates from a location different from the one of the other attendee users among the conference attendee users, that is, when the locations of all the attendee users (getting-on places) are the same (negative determination at step S109), the execution of the process ends. On the other hand, if there is an attendee user who participates from a location different from the one of the other attendee users among the conference attendee users (affirmative determination at step S109), the processing of step S110 and step S111 is executed.

At step S110, the vehicle booking unit 1021 sets a travel route from a getting-on place of the driver candidate to the conference venue through getting-on places of the other attendee users. Then, the vehicle booking unit 1021 transmits a guidance instruction to the on-vehicle device 200 of the company car 20 to be booked, at the start date and time of the scheduled lending period or at a timing immediately therebefore (step S111). The travel route setting may be performed when the driver candidate is determined. In the on-vehicle device 200 having received the guidance instruction, the controller 202 performs route guidance for the driver candidate, based on the travel route included in the guidance instruction. Both the authentication data for authenticating the driver candidate and the guidance instruction may be simultaneously transmitted to the on-vehicle device 200 of the company car 20 to be booked.

According to the process of FIG. 11, when there is an attendee user out of the attendee users who participates from a location different from the one of the other attendee users among the attendee users, all the attendee users can make a trip to the conference venue by one company car 20 without unnecessarily increasing a load on the driver candidate.

<Second Modification>

An attendee user who has the highest safe driving level among attendee users may not always be appropriate as the driver candidate. More specifically, it is also envisaged that the safe driving level of the attendee user who has the highest safe driving level among attendee users may be lower than a predetermined threshold (for example, the number of accidents may be more than a predetermined number of times, the evaluation may be lower than a predetermined evaluation, or the insurance grade may be lower than a predetermined grade). In such a case, if the attendee users are permitted to make a trip by a company car 20, it can cause a deterioration of safety.

Therefore, when the safe driving level of an attendee user who has the highest safe driving level among attendee users is lower than a predetermined threshold value, the lending of a company car 20 may be inhibited. More specifically, the controller 102 of the server device 100 may perform only booking of a conference venue and schedule setting of the attendee users without booking a company car 20. In addition, the controller 102 may transmit information for encouraging a trip by a public transport service, to the user terminal 300 of each of the attendee users. At this time, information on a public transport service available in making a trip from a departure place of the attendee user to the conference venue may be transmitted to the user terminal 300 from the server device 100. When there are a plurality of available public transport services, the controller 102 may transmit information on the plurality of public transport services to the user terminal 300 of each of the attendee users. In addition, the controller 102 may transmit only information on a public transport service that requires the minimum time to make a trip to the conference venue, among the plurality of public transport services, to the user terminal 300 of each of the attendee users.

This modification can prevent a deterioration of the safety of each attendee user. In addition, it can save the attendee user from having to find a public transport service that is available in making a trip to the conference venue.

<Third Modification>

In addition, it is also envisaged that since the number of company cars 20 managed by the company car management system is limited, there may be no company car 20 that can be booked for a scheduled lending period. In this case, the controller 102 of the server device 100 may perform only booking of a conference venue and schedule setting of attendee users. In addition, the controller 102 may transmit information on a trip method as an alternative to a company car 20, to the user terminal 300 of each of the attendee users. For example, when there is an attendee user who is suitable as the driver candidate among attendee users, the controller 102 may transmit information for encouraging a trip by a rental car, to the user terminal 300 of each of the attendee users. In this case, when information indicating a desire to make a trip by a rental car is returned from the user terminal 300 to the server device 100, the controller 102 may book a rental car. When there is no attendee user who is suitable as the driver candidate among the attendee users, the controller 102 may transmit information for encouraging a trip by a public transport service, to the user terminal 300 of each of the attendee users. At this time, information on a public transport service that is available in making a trip from a departure place of the attendee user to the conference venue may be transmitted from the server device 100 to the user terminal 300. When there are a plurality of available public transport services, the controller 102 may transmit information on these plurality of public transport services to the user terminal 300 of each of the attendee users. In addition, the controller 102 may transmit only information on a public transport service that requires the minimum time to make a trip to the conference venue, among the plurality of public transport services, to the user terminal 300 of each of the attendee users.

This modification can save an attendee user from having to find an alternative trip method or having to book an alternative trip method when there is no bookable company car 20.

<Fourth Modification>

It is also envisaged that an attendee user may not desire to make a trip by a company car 20. For example, when a social gathering with drinking is scheduled after a conference, attendee users are to desire to make a trip by a public transport service. In this case, the controller 102 of the server device 100 may perform only booking of a conference venue and schedule setting of each attendee user. Then, the controller 102 may transmit information on a public transport service that is available in making a trip from a departure place of the attendee users to the conference venue, to the user terminal 300 of each of the attendee users. When there are a plurality of available public transport services, the controller 102 may transmit information on these plurality of public transport services to the user terminal 300 of each of the attendee users. In addition, the controller 102 may transmit only information on a public transport service that requires the minimum time to make a trip to the conference venue, among the plurality of public transport services, to the user terminal 300 of each of the attendee users. This can save, when an attendee user does not desire to make a trip by the company car 20, the attendee user from having to find a public transport service.

<Fifth Modification>

Here, there is a possibility that the time required to make a trip from a departure place to a conference venue by a company car 20 (first required time) is more than the time required to make a trip from the departure place to the conference venue by a public transport service (second required time). In such a case, a trip by a company car 20 may reduce the efficiency of work because of unnecessarily long trip time.

Therefore, when the first required time is more than the second required time, the controller 102 may transmit information for encouraging a trip by the public transport service to the user terminal of each attendee user. At this time, information on the public transport service that is available in making a trip from the departure place of the attendee user to the conference venue may also be transmitted from the server device 100 to the user terminal 300. When there are a plurality of available public transport services, the controller 102 may transmit information for encouraging a trip by a public transport service having the minimum required time among the plurality of public transport services, to the user terminal 300 of the attendee user.

This modification can minimize a trip time that is taken when an attendee user participates in a conference. As a result, reduction in the efficiency of work can also be prevented.

<Sixth Modification>

When each attendee user agrees to make a trip by a public transport service in the second modification to fifth modification described above, the controller 102 may book a seat and the like on the public transport service if required. This can save, when an attendee user makes a trip by a public transport service, the attendee user from having to book a seat and the like on the public transport service.

<Seventh Modification>

Here, when there are a plurality of attendee users, the controller 102 may determine a seat position of each of the attendee users on a company car 20 and provide information indicating the seat position of each of the attendee users, to each of the attendee users when the attendee users get on the company car 20. In this case, the seat position of each of the attendee users may be randomly determined by the controller 102 or may be determined based on each of the attendee users' desire. The seat position of each of the attendee users can be notified to each of the attendee users by using a method in which the controller 102 transmits an instruction for the input/output unit 305 to display the seat position of each of the attendee users, to each user terminal 300. Alternatively, the controller 102 may transmit an instruction to display the seat position of each of the attendee users on a display of the car navigation system, to the on-vehicle device 200.

This modification can save an attendee user from having to determine its seat position when getting on a company car 20.

<Others>

The above embodiment and modifications are merely one example, and the present disclosure can be appropriately modified and implemented without departing from the spirit thereof. For example, processing relating to booking of a company car 20, processing relating to booking of a conference venue, and processing relating to schedule setting of attendee users may be performed on different server devices.

In the above embodiment and modifications, examples of an attendee user making a trip to a conference venue by using any one of a company car 20 or a public transport service have been described. However, it is also envisaged that an attendee user may make a trip to a conference venue by using both a company car 20 and a public transport service. In such a case, the server device 100 may book a public transport service for transfer from a company car 20 in addition to booking of the company car 20, booking of a conference venue, and schedule setting of attendee users.

The embodiments described above are merely examples, and the present disclosure may be changed as appropriate within the scope of the disclosure. Furthermore, the processes and means described in the present disclosure may be freely combined to the extent that no technical conflict occurs. Furthermore, a process that is described to be performed by one device may be shared and performed by a plurality of devices. Alternatively, processes described to be performed by different devices may be performed by one device. Which function is to be implemented by which hardware configuration (server configuration) in a computer system may be flexibly changed.

The present disclosure may also be implemented by supplying computer programs for implementing the functions described in the above embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions such as read-only memories (ROMs), random access memories (RAMs), EPROMs, EEPROMs, magnetic cards, flash memories, and optical cards.

What is claimed is:

1. An information processing apparatus, comprising:
a controller configured to execute:
obtaining conference information including a venue of a conference, date and time of the conference, and information on at least one attendee user, the at least one attendee user being a user to attend the conference;
booking the venue of the conference based on the conference information;
setting a schedule of the attendee user based on the conference information; and
booking a company car for transporting the attendee user to the venue of the conference.

2. The information processing apparatus according to claim 1, wherein
the controller books the company car of a model or number of cars according to number of the attendee users.

3. The information processing apparatus according to claim 1, wherein
when there are a plurality of the attendee users and at least one attendee user out of the attendee users makes a trip to the venue of the conference from a location different from a location of other attendee users, the controller books the company car for each of the locations.

4. The information processing apparatus according to claim 1, wherein
when there are a plurality of the attendee users and at least one attendee user out of the attendee users makes a trip to the venue of the conference from a location different from a location of other attendee users, the controller further executes:
setting a travel route of sequentially passing through each of the locations and reaching to the venue of the conference; and
transmitting an instruction to a car navigation system mounted on the company car to be booked, the instruction being to perform route guidance based on the travel route.

5. The information processing apparatus according to claim 1, wherein
when there are a plurality of the attendee users, the controller selects a driver candidate from among the plurality of the attendee users, the driver candidate being an attendee user candidate for driving the company car to be booked.

6. The information processing apparatus according to claim 5, wherein
the controller extracts an attendee user having a highest safe driving level among the plurality of the attendee users based on a driving track record of each of the plurality of the attendee users, and selects the extracted attendee user as the driver candidate.

7. The information processing apparatus according to claim 6, wherein
the driving track record includes information on the number of accidents caused by each of the plurality of the attendee users before; and
the controller selects, as the driver candidate, an attendee user having caused a least number of accidents, among the plurality of the attendee users.

8. The information processing apparatus according to claim 6, wherein
the driving track record includes information on a driving evaluation of each of the plurality of the attendee users; and
the controller selects, as the driver candidate, an attendee user having a highest evaluation, among the plurality of the attendee users.

9. The information processing apparatus according to claim 6, wherein
the driving track record includes information on a grade of car insurance of each of the plurality of the attendee users; and
the controller selects, as the driver candidate, an attendee user having a highest grade of car insurance, among the plurality of the attendee users.

10. The information processing apparatus according to claim 5, wherein
when there is no attendee user suitable as the driver candidate among the plurality of the attendee users, the controller transmits, without booking the company car, information for encouraging a trip by a public transport service, to a user terminal used by each of the attendee users.

11. The information processing apparatus according to claim 1, wherein
the controller further executes:
determining a seat position of the attendee user on the company car to be booked; and
causing a display device or a terminal to display the seat position of the attendee user at a timing of the attendee user getting on the company car to be booked, the display device being mounted on the company car to be booked, the terminal being used by the attendee user.

12. The information processing apparatus according to claim 1, wherein
when the attendee user does not desire a trip by the company car, the controller transmits, without booking the company car, information on a public transport service available when the attendee user makes a trip to the venue of the conference, to a terminal used by the attendee user.

13. The information processing apparatus according to claim 1, wherein
when the company car for transporting the attendee user to the venue of the conference cannot be booked, the controller transmits information on a public transport service available when the attendee user makes a trip to the venue of the conference, to a terminal used by the attendee user.

14. The information processing apparatus according to claim 1, wherein
the controller executes:
predicting a first required time, the first required time being time required for the attendee user to make a trip to the venue of the conference by the company car;
obtaining a second required time, the second required time being time required for the attendee user to make a trip to the venue of the conference by a public transport service; and
booking the company car when the first required time is equal to or less than the second required time, and transmitting information for encouraging a trip by the public transport service to a terminal of the attendee user when the first required time is more than the second required time.

15. The information processing apparatus according to claim 14, wherein
when there are a plurality of the public transport services available for making a trip to the venue of the conference, the controller transmits, to the terminal of the attendee user, information for encouraging a trip by a public transport service requiring a minimum time to make a trip to the venue of the conference among the plurality of the public transport services.

16. An information processing method executed by a computer, comprising:
obtaining conference information including a venue of a conference, date and time of the conference, and information on at least one attendee user, the at least one attendee user being a user to attend the conference;
booking the venue of the conference based on the conference information;
setting a schedule of the attendee user based on the conference information; and
booking a company car for transporting the attendee user to the venue of the conference.

17. The information processing method according to claim 16, wherein
when the company car for transporting the attendee user to the venue of the conference is booked, the company car of a model or number of cars according to number of the attendee users is booked.

18. The information processing method according to claim 16, wherein
when there are a plurality of the attendee users and at least one attendee user out of the attendee users makes a trip to the venue of the conference from a location different from a location of other attendee users, the company car is booked for each of the locations when the company car for transporting the attendee user to the venue of the conference is booked.

19. The information processing method according to claim 16, wherein
when there are a plurality of the attendee users and at least one attendee user out of the attendee users makes a trip to the venue of the conference from a location different from a location of other attendee users, the computer further executes:
setting a travel route of sequentially passing through each of the locations and reaching to the venue of the conference; and
transmitting an instruction to a car navigation system mounted on the company car to be booked, the instruction being to perform route guidance based on the travel route.

20. A non-transitory storage medium having a program stored therein, the program causing a computer to execute the information processing method according to claim 16.
